(19) United States
(12) Patent Application Publication
(10) Pub. No.: US 2013/0167086 A1
(43) Pub. Date: Jun. 27, 2013

(54) DIGITAL IMAGE PROCESSING APPARATUS AND METHOD OF CONTROLLING THE SAME

(71) Applicant: SAMSUNG ELECTRONICS CO., LTD., Suwon-si (KR)

(72) Inventors: Hye-jin Kim, Seoul (KR); Se-hyun Park, Yongin-si (KR); Jin-pyo Gwak, Seoul (KR); Hoe-won Kim, Daejeon (KR)

(73) Assignee: SAMSUNG ELECTRONICS CO., LTD., Suwon-si (KR)

(21) Appl. No.: 13/709,532

(22) Filed: Dec. 10, 2012

(30) Foreign Application Priority Data
Dec. 23, 2011 (KR) 10-2011-0141730

(51) Int. Cl. G06F 3/0481

(52) U.S. Cl. CPC G06F 3/0481
USPC 715/810

(57) ABSTRACT

A digital image processing apparatus and a method of controlling the digital image processing apparatus, the digital image processing apparatus including: a display unit to display an image; a tool generation unit to generate an editing tool that applies an image editing effect to a displayed image; an effect generation unit to generate the image editing effect depending on a movement of the editing tool; and a contents generation units to generate a moving image including a generation process of the image editing effect and the movement of the editing tool.

### CROSS-REFERENCE TO RELATED PATENT APPLICATION

This application claims the priority benefit of Korean Patent Application No. 10-2011-0141730, filed on Dec. 23, 2011, in the Korean Intellectual Property Office, which is incorporated herein in its entirety by reference.

### BACKGROUND

1. Field

The invention relates to a digital image processing apparatus and a method of controlling the same.

2. Description of the Related Art

Digital image processing apparatuses such as digital cameras or camcorders are easy to carry because of miniaturization of the digital image processing apparatuses and technological development of, for example, a battery, and thus, the digital image processing apparatuses may easily capture an image anywhere. Also, the digital image processing apparatuses provide various functions that may allow even a layman to easily capture an image.

In addition, digital image processing apparatuses provide various functions, for example, a function of editing a captured image during image capturing or after image capturing so that a user may easily obtain a desired image.

### SUMMARY

The invention provides a digital image processing apparatus to generate a moving image related to a still image.

The invention also provides a method of controlling the digital image processing apparatus.

According to an aspect of the invention, there is provided a digital image processing apparatus including: a display unit to display an image; a tool generation unit to generate an editing tool that applies an image editing effect to a displayed image; an effect generation unit to generate the image editing effect depending on a movement of the editing tool; and a contents generation units to generate a moving image including a generation process of the image editing effect and the movement of the editing tool.

The displayed image and the moving image may be stored in a single file.

The contents generation unit may record information for relating the displayed image with the moving image in an exchangeable image file format (EXIF) area of the single file.

The displayed image and the moving image may be stored in separate files.

The image may be a quick view image that is temporarily displayed on the display unit after still image capture.

The editing tool may be displayed on the display unit during the performance of an image signal processing due to the still image capture.

The image may be an image reproduced from a stored image.

The digital image processing apparatus may further include a manipulation unit to move the editing tool.

The manipulation unit may include a touch panel.

The manipulation unit may include input keys.

The editing tool may include at least one of a watercolor painting brush, an oil painting brush, or a pencil.

The tool generation unit may generate usable editing tools according to a manipulation signal of a user and then may display the usable editing tools.

The tool generation unit may display an editing tool selected from among the displayed usable editing tools, and the effect generation unit may generate an intrinsic image editing effect of the selected editing tool.

According to another aspect of the invention, there is provided a method of controlling a digital image processing apparatus, the method including: displaying an image; displaying an editing tool to generate an image editing effect; displaying the image editing effect depending on a movement of the editing tool; and generating a moving image including a generation process of the image editing effect and the movement of the editing tool.

The displaying of the editing tool may include: generating usable editing tools according to a manipulation signal of a user and then displaying the usable editing tools; and displaying an editing tool selected from among the displayed usable editing tools.

The displaying of the image editing effect may include generating an intrinsic image editing effect of the selected editing tool.

The method may further include storing the displayed image and the moving image in separate files.

The method may further include storing the displayed image and the moving image in a single file.

The method may further include capturing a still image, wherein the displaying of the image includes displaying a quick view image that is temporarily displayed on a display unit after the capture of the still image.

The method may further include extracting a stored image, wherein the displaying of the image includes displaying the extracted image.

According to another aspect of the invention, there is provided a digital image processing apparatus including: a storage unit to store a still image and a moving image related to the still image; a display unit to display the stored still image and moving image; and a control unit to control the display unit, wherein the moving image includes a generation process of an image editing effect generated by a user for the still image and a movement of an editing tool to generate the image editing effect.

The still image or the moving image may be selectively reproduced.

When reproducing the still image, the moving image may be first reproduced and the still image may be reproduced after the reproduction of the moving image is finished.

The storage unit may store the still image and the moving image as a single file.

A user interface to execute a reproduction of the moving image may be displayed during a reproduction of the still image.

The storage unit may store the still image and the moving image as separate files.

The digital image processing apparatus may further include a contents generation unit to generate another still image by capturing a frame of the moving image depending on a capture signal when reproducing the moving image.

According to another aspect of the invention, there is provided a method of controlling a digital image processing apparatus that stores a still image and a moving image related to the still image, the method including: when reproducing the moving image, reproducing a generation process of an image editing effect generated by a user and a movement of an editing tool to generate the image editing effect.

The still image or the moving image may be selectively reproduced.

A user interface to execute a reproduction of the moving image may be displayed during a reproduction of the still image.

When reproducing the still image, the moving image may be first reproduced and the still image may be reproduced after the reproduction of the moving image is finished.

When reproducing the moving image, another still image may be generated by capturing a frame of the moving image depending on a capture signal.

### BRIEF DESCRIPTION OF THE DRAWINGS

The above and other features and advantages of the invention will become more apparent upon review of detail exemplary embodiments thereof with reference to the attached drawings in which:

FIG. 1 is a block diagram of a digital image processing apparatus according to an embodiment of the invention;

FIG. 2 is a block diagram of the central processing unit (CPU) of FIG. 1, according to an embodiment of the invention;

FIGS. 3 and 4 are flowcharts illustrating a method of controlling the digital image processing apparatus, according to an embodiment of the invention;

FIGS. 5A, 5B, 6A, 6B, 7A and 7B are images illustrating an image editing mode according to an embodiment of the invention;

FIG. 8 is a flowchart illustrating a method of controlling the digital image processing apparatus, according to another embodiment of the invention;

FIG. 9 is a flowchart illustrating a method of controlling the digital image processing apparatus, according to another embodiment of the invention;

FIG. 10 is an image illustrating a reproducing mode of the digital image processing apparatus, according to an embodiment of the invention;

FIG. 11 is an image illustrating a reproducing mode of the digital image processing apparatus, according to another embodiment of the invention;

FIG. 12 are images illustrating a reproducing mode of the digital image processing apparatus, according to another embodiment of the invention; and

FIG. 13 is a flowchart illustrating a method of controlling the digital image processing apparatus, according to another embodiment of the invention

### DETAILED DESCRIPTION

Hereinafter, the invention will be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, like reference numerals denote like elements.

As used herein, the term “and/or” includes any and all combinations of one or more of the associated listed items. Expressions such as “at least one of,” when preceding a list of elements, modify the entire list of elements and do not modify the individual elements of the list.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, the invention will be described in detail by explaining exemplary embodiments of the invention with reference to the attached drawings. The same reference numerals in the drawings denote the same element and the detailed descriptions thereof will be omitted.

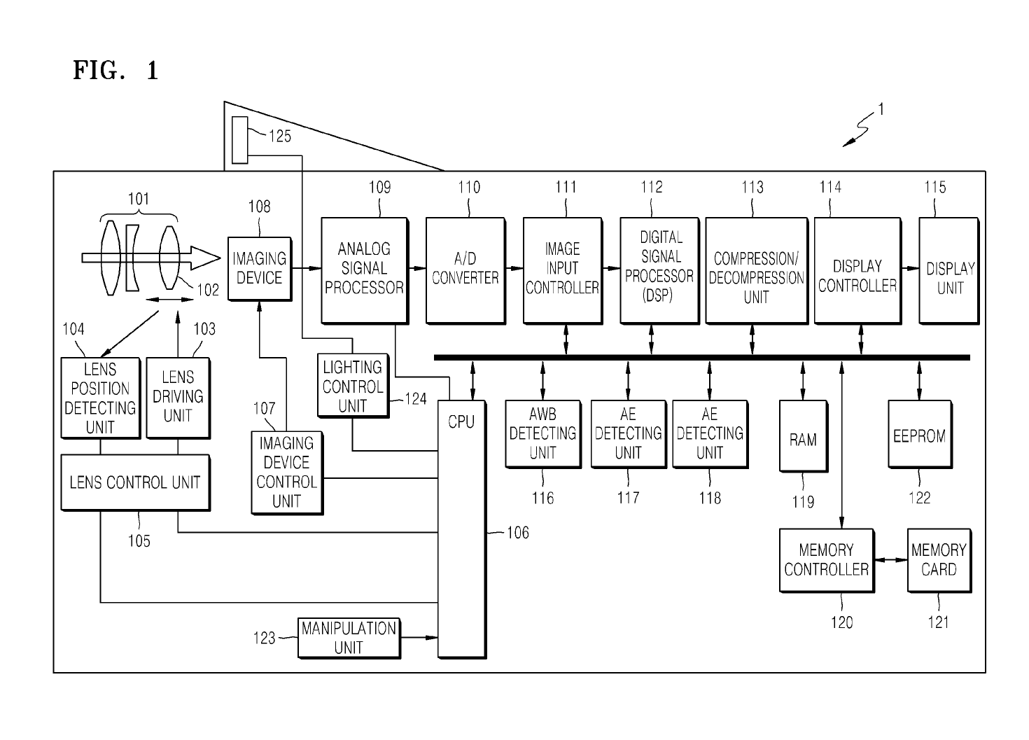

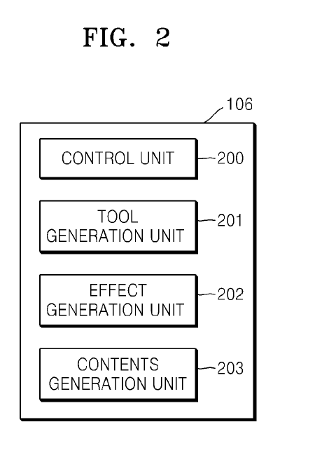

FIG. 1 is a block diagram of a digital image processing apparatus 1 according to an embodiment of the invention. FIG. 2 is a block diagram of the central processing unit (CPU) 106 of FIG. 1, according to an embodiment of the invention.

Referring to FIG. 1, the digital image processing apparatus 1 includes an imaging lens 101, a lens driving unit 103, a lens position detecting unit 104, a lens control unit 105, the CPU 106, an imaging device control unit 107, an imaging device 108, an analog signal processor 109, an analog/digital (A/D) converter 110, an image input controller 111, a digital signal processor (DSP) 112, a compression/decompression unit 113, a display controller 114, a display unit 115, an auto white balance (AWB) detecting unit 116, an auto exposure (AE) detecting unit 117, an auto focus (AF) detecting unit 118, a random access memory (RAM) 119, a memory controller 120, a memory card 121, an electrically erasable programmable read only memory (EEPROM) 122, a manipulation unit 123, a lighting control unit 124, and a lighting apparatus 125.

The imaging lens 101 includes a focus lens 102, and may perform a function of controlling a focus by driving the focus lens 102.

The lens driving unit 103 drives the focus lens 102 under the control of the lens control unit 105, and the lens position detecting unit 104 detects a position of the focus lens 102 and transmits a detection result to the lens control unit 105.

The lens control unit 105 controls an operation of the lens driving unit 103, and receives position information from the lens position detecting unit 104. In addition, the lens control unit 105 communicates with the CPU 106, and transmits or receives information about focus detection to or from the CPU 106.

The CPU 106 controls an entire operation of the digital image processing apparatus 1. Referring to FIG. 2, the CPU 106 includes a control unit 200, a tool generation unit 201, an effect generation unit 202, and a contents generation unit 203.

The control unit 200 controls operations of internal elements and external elements of the CPU 106. The control unit 200 may control the display controller 114 to display various images on the display unit 115. For example, in a photographing mode, the control unit 200 controls the display controller 114 to display a live view image, a quick view image, or the like. In addition, in a reproducing mode, the control unit 200 controls the display controller 114 to reproduce an image selected by a user.

The tool generation unit 201 generates editing tools for image editing effects. For example, the editing tools may include a watercolor painting brush, an oil painting brush, a pencil, and the like. In addition, the editing tools may include various art tools such as a knife, a chisel, a color pencil, a charcoal pencil, a pastel pencil, a conte crayon, an oriental painting brush, and the like.

The effect generation unit 202 generates various kinds of image editing effects depending on a movement of an editing tool generated by the tool generation unit 201. For example, in a case in which a pencil is generated as an editing tool and displayed on the display unit 115, a line is generated depending on a movement of the pencil when a user manipulates the pencil to move. That is, the effect generation unit 202 allows intrinsic effects of a generated editing tool to be displayed on the display unit 115 depending on a movement of the generated editing tool.

The contents generation units 203 generates contents that are related to the generated editing tool and an image editing effect generated due to a movement of the generated editing tool. The generated contents are moving images that include a movement of an editing tool manipulated by a user, and include a process of generating an image editing effect depending on the movement of the editing tool.

When reproducing generated moving images, if a user applies an image capture signal, the contents generation unit 203 generates a still image by capturing a frame image when the image capture signal is applied.

The contents generation unit 203 may generate a single file including a still image and a moving image generated from the still image, and then may store the single file. The contents generation unit 203 may record information for relating the still image with the moving image in an exchangeable image file format (EXIF) area of the single file. For example, the contents generation unit 203 may record the information for relating the still image with the moving image in a maker note area of the EXIF area in which a user may arbitrary record content.

In addition, the contents generation unit 203 may generate the still image and the moving image generated from the still image as separate files, and then may store the separate files.

Returning to FIG. 1, the imaging device control unit 107 generates a timing signal and applies the timing signal to the imaging device 108, and thus, controls an imaging operation of the imaging device 108. Also, as accumulation of charges in each scan line of the imaging device 108 is finished, the imaging device control unit 107 controls the imaging device 108 to sequentially read an image signal.

The imaging device 108 captures a subject's image light that has passed through the imaging lens 101 to generate an image signal. The imaging device 108 may include a plurality of photoelectric conversion devices arranged in a matrix form, charge transmission paths for transmitting charges from the photoelectric conversion devices, and the like.

The analog signal processor 109 removes noise from the image signal generated by the imaging device 108 or amplifies a magnitude of the image signal to an arbitrary level. The A/D converter 110 converts an analog image signal that is output from the analog signal processor 109 into a digital image signal. The image input controller 111 processes the image signal output from the A/D converter 110 so that an image process may be performed on the image signal in each subsequent component.

The AWB detecting unit 116, the AE detecting unit 117, and the AF detecting unit 118 perform AWB processing, AE processing, and AF processing on the image signal output from the image input controller 111, respectively.

The image signal output from the image input controller 111 may be temporarily stored in the RAM 119 including a synchronous dynamic random access memory (SDRAM) or the like.

The DSP 112 performs a series of image signal processing operations, such as gamma correction, on the image signal output from the image input controller 111 to generate a live view image or a captured image that is displayable on the display unit 115. In addition, the DSP 112 may perform white balance adjustment of a captured image depending on a white balance gain detected by the AWB detecting unit 116. That is, the DSP 112 and the AWB detecting unit 116 may be an example of a white balance control unit.

The compression/decompression unit 113 performs compression or decompression on an image signal on which image signal processing has been performed. Regarding compression, the image signal is compressed in, for example, JPEG compression format or H.264 compression format. An image file, including image data generated by the compression processing, is transmitted to the memory controller 120, and the memory controller 120 stores the image file in the memory card 121.

The display controller 114 controls an image to be output by the display unit 115. The display unit 115 displays various images, such as a captured image, a live view image, and a quick view image that is temporarily displayed after image capturing, various setting information, and the like. The display unit 115 and the display controller 114 may include a liquid crystal display (LCD) and an LCD driver, respectively. However, the invention is not limited thereto, and the display unit 115 and the display controller 114 may include, for example, an organic light-emitting diode (OLED) display and a driving unit thereof, respectively.

The RAM 119 may include a video RAM (VRAM) that temporarily stores information such as an image to be displayed on the display unit 115.

The memory controller 120 controls data input to the memory card 121 and data output from the memory card 121.

The memory card 121 may store a file including a still image or a moving image. The memory card 121 may store a still image and a moving image related to the still image as a single file or as separate files according to a contents generation method of the contents generation unit 230.

The EEPROM 122 may store an execution program for controlling the digital image processing apparatus 1 or management information.

The manipulation unit 123 is a unit through which a user inputs various commands for manipulating the digital image processing apparatus 1. The manipulation unit 123 may include various input keys such as a shutter release button, a main switch, a mode dial, a menu button, a four direction button, a jog dial, or the like. In addition, the manipulation unit 123 may sense a user's touch, and may include a touch panel for generating a command depending on the touch. When an editing tool is generated by the tool generation unit 201 and then displayed on the display unit 115, the manipulation unit 123 may make the displayed editing tool move depending on a user's manipulation.

The lighting control unit 124 is a circuit for driving the lighting apparatus 125 to illuminate a photography auxiliary light or an AF auxiliary light.

The lighting apparatus 125 is an apparatus for emitting an auxiliary light necessary during AF driving or photography. The lighting apparatus 125 irradiates light to a subject during photography or AF driving under a control of the lighting control unit 124.

Although, in the current embodiment, the CPU 106 includes the control unit 200, the tool generation unit 201, the effect generation unit 202, and the contents generation unit 203, the invention is not limited thereto. For example, the DSP 112 may include the tool generation unit 201 or the effect generation unit 202, and the compression/decompression unit 113 may include the contents generation unit 203.

Hereafter, various methods of controlling the digital image processing apparatus 1 are explained.

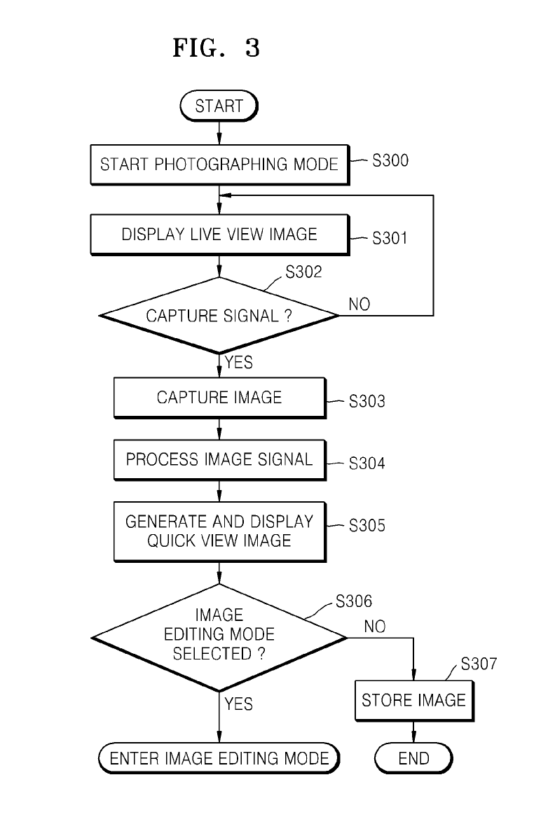

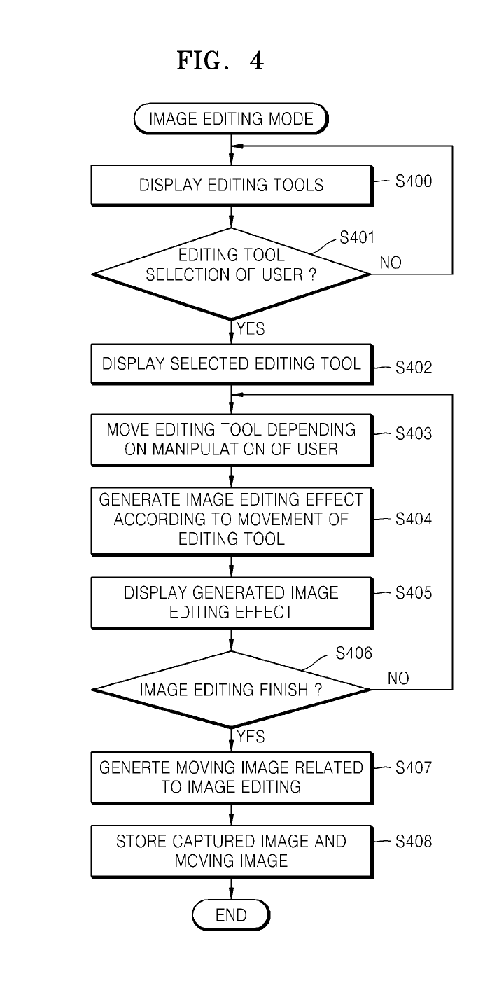

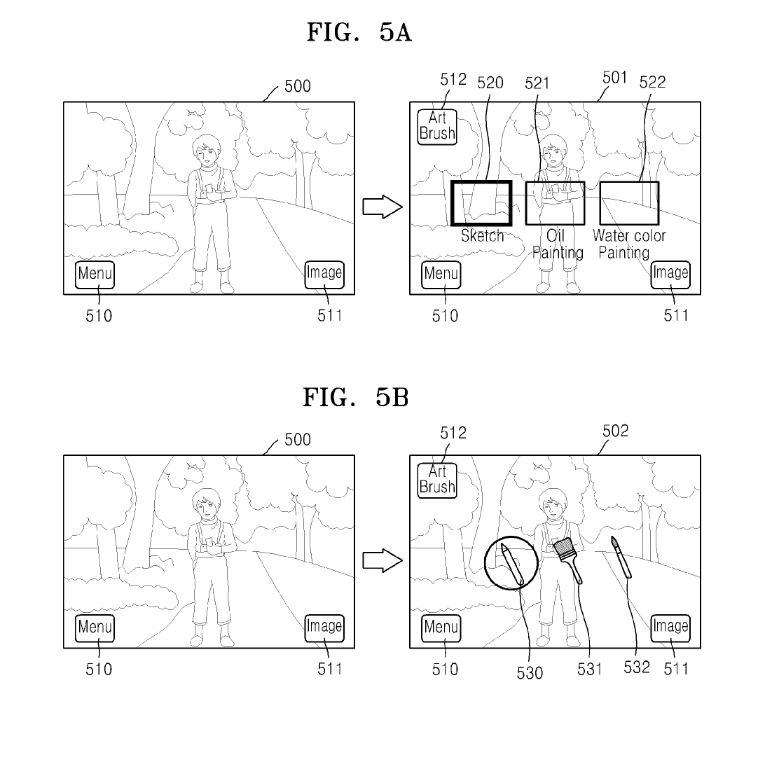

FIGS. 3 and 4 are flowcharts illustrating a method of controlling the digital image processing apparatus 1, according to an embodiment of the invention. FIGS. 5A, 5B, 6A, 6B, 7A and 7B are images illustrating an image editing mode according to an embodiment of the invention.

The embodiment of FIG. 3 relates a case in which a still image is captured in a photographing mode, and an image editing mode is executed for a quick view image in the middle of image signal processing.

Referring to FIG. 3, in a case in which the digital image processing apparatus 1 is a photographing apparatus, a live view image is displayed when the photographing mode is started (operations S300 and S301). It is determined whether a user has applied a capture signal for capturing an image (operation S302). If the capture signal has not been applied, the live view image is continuously displayed, and a standby state for image capturing is maintained.

Otherwise, if the capture signal has been applied, an image is captured after performing necessary adjustments such as a focus adjustment and an exposure adjustment (operation S303). Then, an image signal processing is performed on the captured image (operation S304).

A quick view image is generated and then displayed during the image signal processing (operation S305), and it is determined whether or not to perform (e.g., initiate or enter) the image editing mode before the image signal processing is finished (operation S306). In the case where it is determined not to perform the image editing mode, when the image signal processing is finished, a captured still image to which image signal processing has been finished is stored (operation S307).

On the other hand, in the case where it is determined to perform the image editing mode, the photographing apparatus goes into the image editing mode. That is, the image editing mode may be executed while capturing an image and then performing an image signal processing, that is, before the image signal processing is finished.

Hereafter, the method of controlling the digital image processing apparatus 1 illustrated in FIG. 3 is explained in more detail.

Referring to FIG. 5A, the digital image processing apparatus 1 displays a picture 500 of a live view image. An icon 510 on the lower left corner of the picture 500 is a menu icon Menu, and various kinds of menus that may be selected in the photographing mode are displayed when a user selects the menu icon 510. An icon 511 on the lower right corner of the picture 500 is an image icon Image, and a stored image may be reproduced when a user selects the image icon 511.

When a user executes the image editing mode in a state as the left image of FIG. 5A, a picture 501 showing editing tools that are selectable by a user is displayed. An icon 512 on the left upper corner of the picture 501 is an image editing mode icon Art Brush that indicates that the image editing mode is being executed.

Usable editing tools, i.e., editing tools that are selectable by a user, are displayed on a center portion of the picture 501. A sketch editing tool (Sketch) 520, an oil painting editing tool (Oil Painting) 521, and a watercolor painting editing tool (Watercolor Painting) 522 may be shown in box forms as the editing tools. An editing tool selected by a user may be indicated by a bold line, and editing tools unselected by a user may be indicated by a thin line. However, this is just an example, and colors or forms of the boxes of the editing tools may be changed to distinguish a selected editing tool from unselected editing tools.

Referring to FIG. 5B, the digital image processing apparatus 1 displays a picture 500 of a live view image. When a user executes the image editing mode, a picture 502 showing usable editing tools, i.e., editing tools that are selectable by a user, is displayed. In the current embodiment, a pencil 530, an oil painting brush 531, and a watercolor painting brush 532 may be shown in the center portion of the picture 502 as editing tools that are selectable by a user. In addition, a discrimination mark for indicating which editing tool has been selected may be displayed.

As stated above, while a live view image is displayed in the photographing mode, the image editing mode may be executed by a user and then a specific editing tool may be selected. The execution of the image editing mode may be performed before an image is captured, or may be performed after the image has been captured.

Referring to FIG. 4, if the image editing mode is entered, editing tools are displayed (operation S400), and it is determined whether a user has selected a specific editing tool (operation S401). However, as explained above, operations S400 and S401 may be performed before an image is captured.

When a user selects an editing tool, the selected editing tool is generated and displayed when a quick view image is displayed (operation 402). Then, the generated editing tool is moved depending on a user's manipulation (operation S403).

When the generated editing tool is moved, an intrinsic image editing effect thereof is generated according to a movement thereof (operation S404). Then, the generated image editing effect is displayed (operation S405). For example, the image editing effect may be a shape in which a line is drawn by a pencil or a shape in which a color is applied by an oil painting brush, a watercolor painting brush, or the like. That is, the image editing effect is not a still effect but an effect that is changed in real time depending on a movement of the editing tool.

Next, it is determined whether the image editing has been finished (operation S406). When it is determined that the image editing has not been finished yet, operations S403 through S405 are repeated. On the other hand, when it is determined that the image editing has been finished, a moving image related to the image editing is generated (operation S407). That is, a real time change process of an image editing effect generated depending on a movement of the editing tool is generated as a moving image. The generated moving image includes a movement of an editing tool as well as a changing shape of an image.

When the moving image is generated, a captured image and the moving image are stored in a single file or separate files (operation S408).

Hereafter, the method of controlling the digital image processing apparatus 1, which is illustrated in FIG. 4, is explained in more detail.

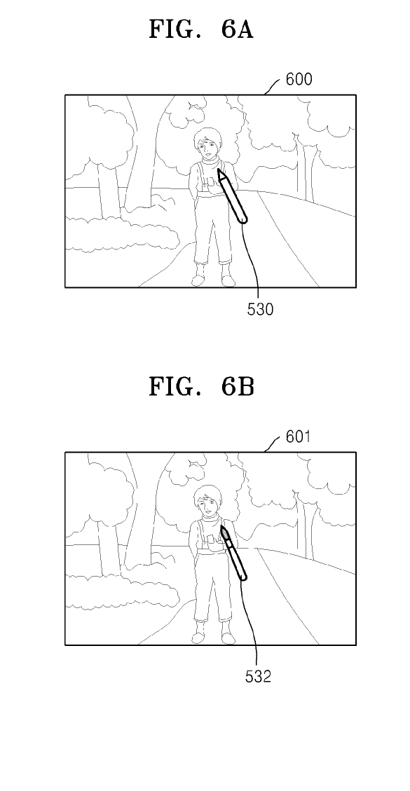

Referring to FIG. 6A, when an image editing mode is executed by a user and then a pencil 530 is selected as an editing tool, the pencil 530, together with a quick view image, is displayed as in a picture 600.

Referring to FIG. 6B, when an image editing mode is executed by a user and then a watercolor painting brush 532 is selected as an editing tool, the watercolor painting brush 532, together with a quick view image, is displayed as in a picture 601.

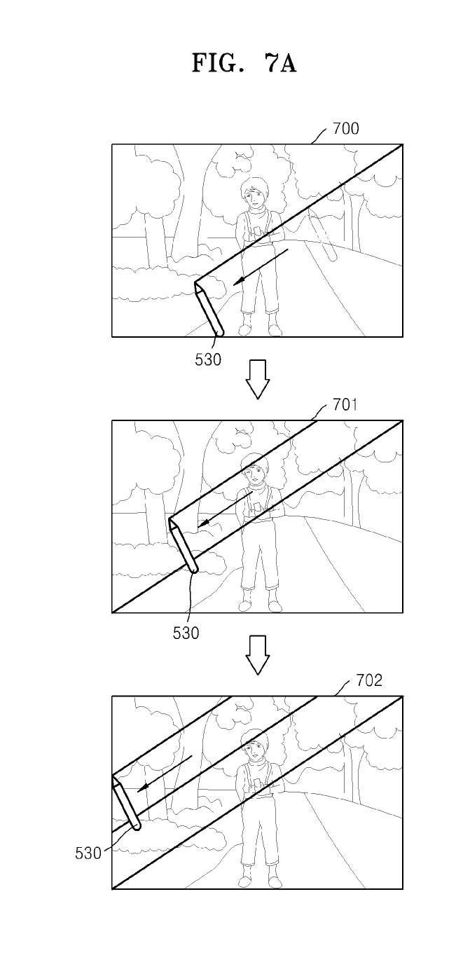

Referring to FIG. 7A, when the pencil 530 is selected as an editing tool, as in pictures 700 through 702, the pencil 530 is moved by a user's manipulation, and an image editing effect in which a line is drawn depending on a movement of the pencil 530 is generated and then displayed.

Referring to FIG. 7B, when the watercolor painting brush 532 is selected as an editing tool, as in pictures 710 through 712, the watercolor painting brush 532 is moved by a user's manipulation, and an image editing effect in which a line is drawn depending on a movement of the watercolor painting brush 532 is generated and then displayed.

The contents generation unit 203 generates a moving image that includes a movement of an editing tool and an image editing effect generated due to the movement of the editing tool, as in FIGS. 7A and 7B.

Although, in FIGS. 7A and 7B, a case where only a single editing tool is used is illustrated, the invention is not limited thereto. For example, while generating an image editing effect by using the pencil 530, the editing tool may be changed from the pencil 530 to the oil painting brush 531 by a user's manipulation, thereby generating a new image editing effect.

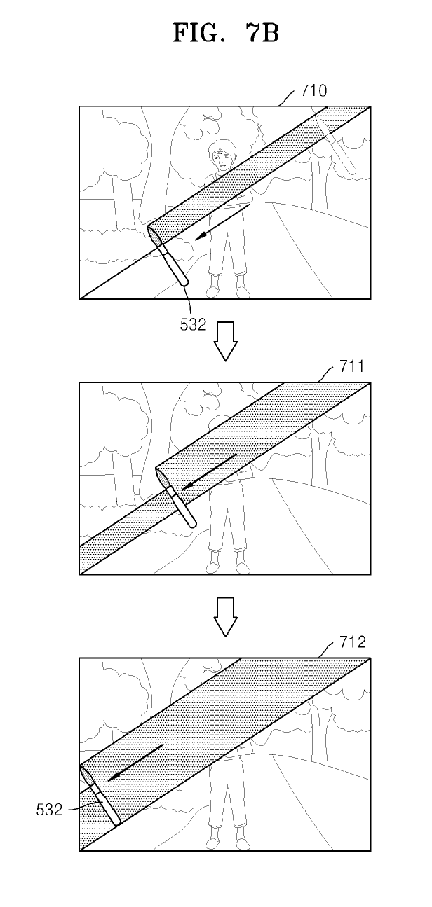

FIG. 8 is a flowchart illustrating a method of controlling the digital image processing apparatus 1, according to another embodiment of the invention. The embodiment of FIG. 8 relates to a reproduction of a still image in a reproducing mode and then an execution of an image editing mode.

Referring to FIG. 8, a reproducing mode starts (operation S801), and an image selected by a user is extracted and then displayed (operation S802).

Next, it is determined whether an image editing mode is executed (i.e., initiated) (operation S803). If it is determined that the image editing mode has not been executed, an operation depending on a user's manipulation is performed (operation S804). For example, a magnification or reduction of a reproduction image, a change of the reproduction image, or an end of the reproducing mode may be performed.

On the other hand, if it is determined that the image editing mode is executed, the image editing mode explained with reference to FIG. 4 is performed.

As stated above, in the digital image processing apparatus 1 and the method of controlling the digital image processing apparatus 1, a user may directly perform image editing on a previously stored image or a newly captured image, and a moving image that includes a movement of an editing tool as well as a generation process of an image editing effect due to an image editing may be generated as new contents. Thus, it is possible to satisfy a user's desire to generate new and unique contents.

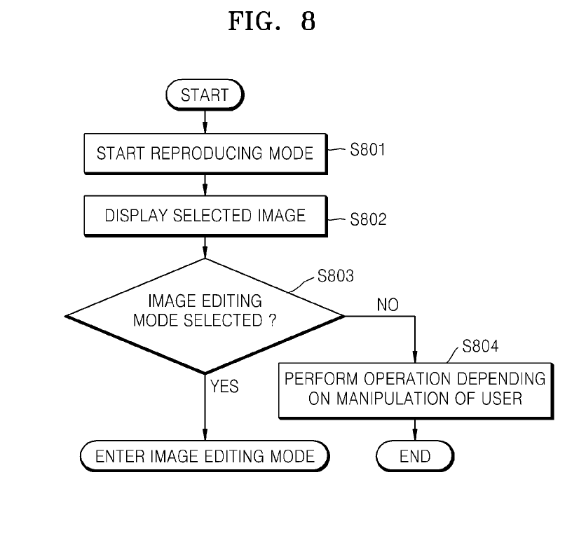

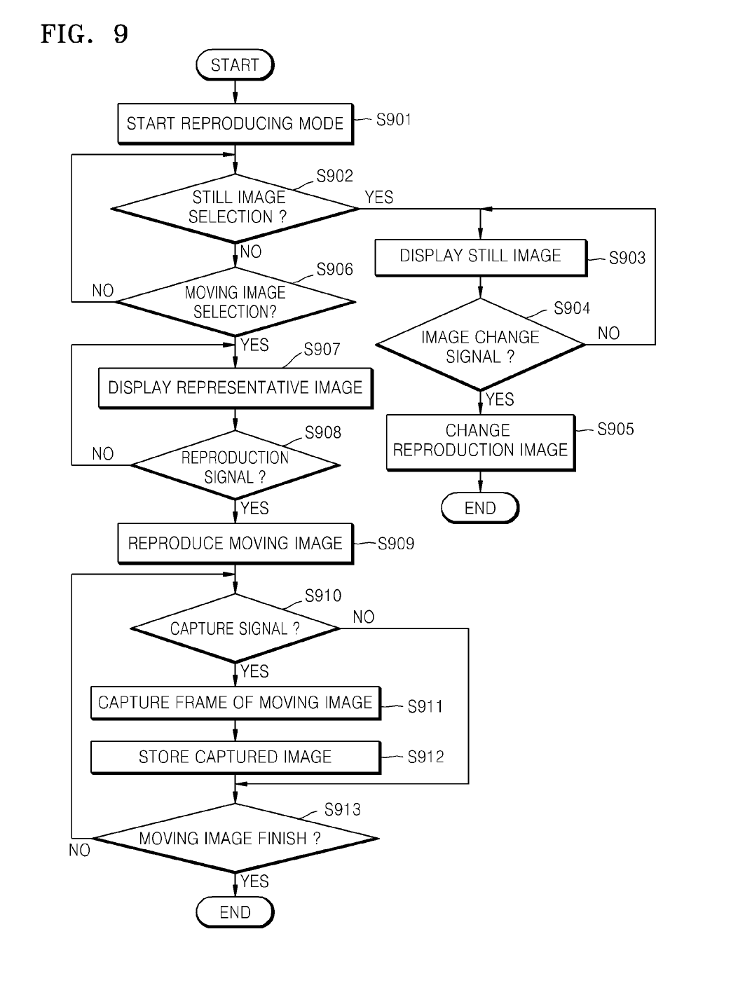

FIG. 9 is a flowchart illustrating a method of controlling the digital image processing apparatus 1, according to another embodiment of the invention. FIGS. 10 through 12 are images illustrating reproducing modes of the digital image processing apparatus 1, according to embodiments of the invention.

The embodiment of FIG. 9 relates to a reproduction of a still image or a moving image when the still image and the moving image related to the still image have been stored in a single file or separate files through an image editing mode as explained with respect to FIG. 4. In the current embodiment, a case in which a general still image and a general moving image are selected is excluded for convenience of explanation.

Referring to FIG. 9, a case in which a still image and a moving image have been stored as separate files is disclosed. First, a reproducing mode starts (operation S901), and it is determined whether a still image has been selected as a reproduction image by a user (operation S902).

If the still image has been selected as the reproduction image, the selected still image is displayed (operation S903). Then, it is determined whether an image change signal has been applied (operation S904), and the reproduction image is changed if the image change signal has been applied (operation S905). Because the still image is being reproduced at this time, an image editing mode as explained with reference to FIGS. 4 and 8 may be executed.

Otherwise, in the operation S902, if the still image has not been selected as the reproduction image, it is determined whether the moving image has been selected as the reproduction image (operation S906). If the moving image has been selected, a representative image of the selected moving image is displayed (operation S907). Then, it is determined whether a reproduction signal has been applied (operation S908), and the moving image is reproduced when the reproduction signal is applied (operation S909). However, operations S907 and S908 may be omitted, and the moving image may be directly reproduced when the moving image is selected in operation S906.

If the moving image has been reproduced, it is determined whether a capture signal has been applied from a user (operation S910). If the capture signal has not been applied, it is determined whether a reproduction of the moving image has been finished (operation S913). If the reproduction of the moving image is not finished, operation S910 starts again. Otherwise, if the reproduction of the moving image is finished, all processes are finished.

On the other hand, when the capture signal is applied, a frame of the moving image is captured (operation S911), and a captured still image is stored (operation S912). The captured still image may be stored in a file different from that of an existing still image or moving image, or may be stored in the same file as the existing still image or moving image.

Next, it is determined whether a reproduction of the moving image has been finished (operation S913). If the reproduction of the moving image is not finished, operation S910 starts again. Otherwise, if the reproduction of the moving image is finished, all processes are finished.

Referring to FIG. 10, a picture 1000 in which a still image is reproduced is shown. In the reproducing mode, an image selected by a user from among stored images is displayed. In the reproducing mode, a reproducing mode icon 1010 indicating the reproducing mode, a delete icon (Del) 1011 for file deletion, a slide icon (Slide Show) 1012 for automatically navigate through reproduction images, and a thumbnail icon 1013 for simultaneously displaying a plurality of thumbnail images may be displayed in turn on the upper left side of the picture 1000.

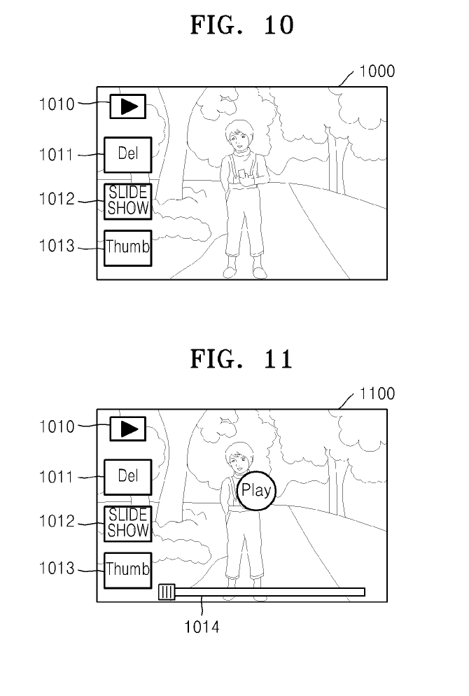

Referring to FIG. 11, a picture 1100 in which a moving image can be selected is shown. When the moving image is selected, a representative image related to the selected moving image may be displayed. In the center portion of the picture 1100, a reproducing icon Play for reproducing the moving image may be generated and then displayed. In one side of the picture 1100, a state bar 1014 indicating a reproduction state of the moving image may be displayed.

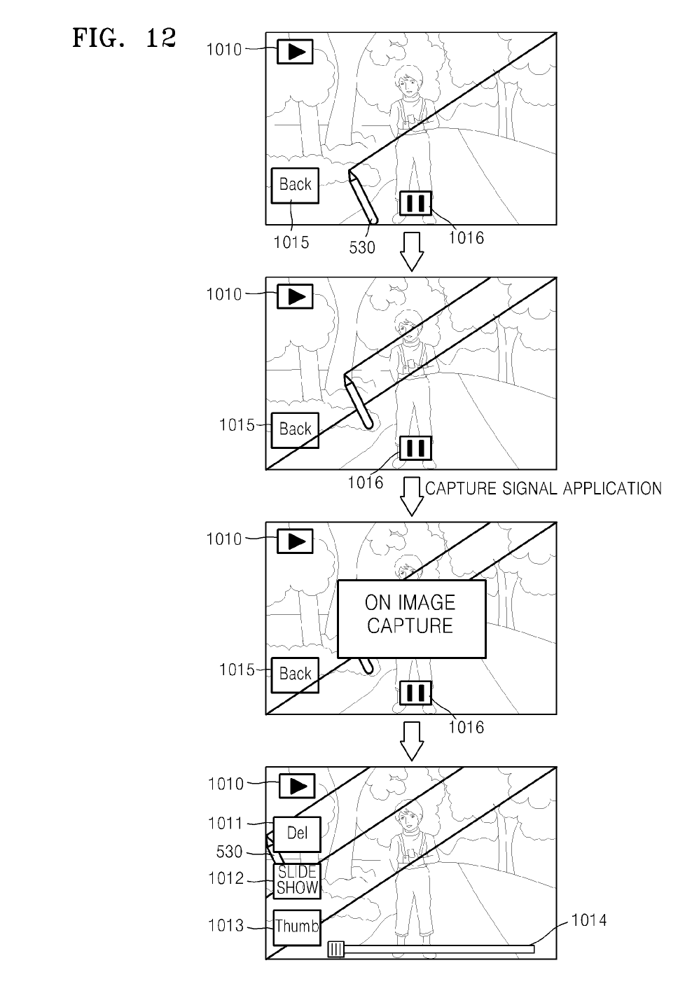

Referring to FIG. 12, pictures in which a selected image is reproduced are shown in turn. When the moving image is reproduced, an end icon (Back) 1015 for ending a reproduction of the moving image may be generated and then displayed, and a pause icon 1016 for pausing the reproduction of the moving image may be generated and then displayed.

When an image capture signal is applied during the reproduction of the moving image, a frame image when the image capture signal is applied may be captured and then stored in an independent file or in an existing still image file or moving image file.

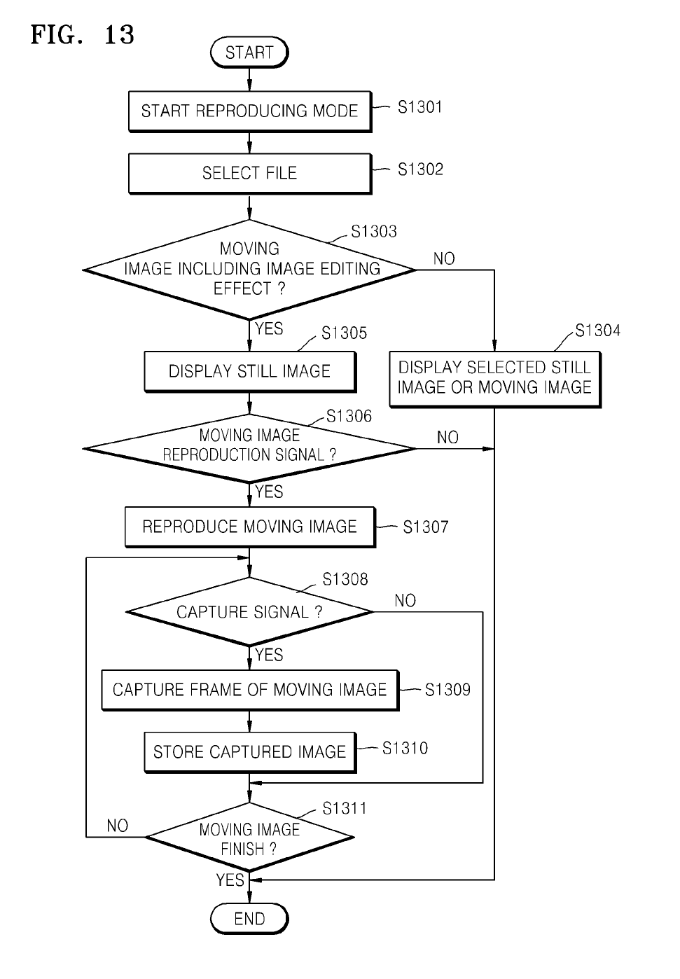

FIG. 13 is a flowchart illustrating a method of controlling the digital image processing apparatus 1, according to another embodiment of the invention.

Referring to FIG. 13, a case in which a still image and a moving image have been stored in a single file is disclosed. A reproducing mode starts (operation S1301), a file is selected by a user (operation S1302), and then it is determined whether the selected file includes a moving image including an image editing effect (operation S1303). If the selected file does not include a moving image including an image editing effect, a general file, i.e., a still image or moving image, is displayed (operation S1304).

Otherwise, if the selected file includes a moving image including an image editing effect, a still image included in the file is first displayed (operation S1305). A reproducing icon that is capable of reproducing a moving image together with a still image may be displayed.

It is determined whether a moving image reproduction signal is applied (operation S1306), and a moving image stored together with a still image being reproduced is reproduced when the reproducing icon is selected and the moving image reproduction signal is applied (operation S1307). If the moving image reproduction signal is not applied, only an operation depending on a user's manipulation is performed. For example, another file may be reproduced, or the reproducing mode may be finished.

When the moving image is reproduced, in operations S1308 through S1311, operations like operations S910 through S913 of FIG. 9 may be performed. At this time, a newly captured and generated still image may be inserted and then stored in an existing file.

In the current embodiments, as explained above, in a case where a still image and a moving image are in a single file, when the single file is selected, the still image is first reproduced and the moving image is reproduced depending on a user's manipulation. However, this is an exemplary case, and the invention is not limited thereto. For example, when a specific file is selected, a moving image is first reproduced and a still image may be reproduced after the reproduction of the moving image is finished.

As stated above, in the digital image processing apparatus 1 and the methods of controlling the digital image processing apparatus 1, a user directly may perform image editing on a previously stored image or a newly captured image, and a moving image that includes a movement of an editing tool as well as a generation process of an image editing effect due to an image editing may be generated as new contents. Thus, it is possible to satisfy a user's desire to generate new and unique contents.

The embodiments disclosed herein may include a memory for storing program data, a processor for executing the program data to implement the methods and apparatus disclosed herein, a permanent storage such as a disk drive, a communication port for handling communication with other devices, and user interface devices such as a display, a keyboard, a mouse, etc. When software modules are involved, these software modules may be stored as program instructions or computer-readable codes, which are executable by the processor, on a non-transitory or tangible computer-readable media such as a read-only memory (ROM), a random-access memory (RAM), a compact disc (CD), a digital versatile disc (DVD), a magnetic tape, a floppy disk, an optical data storage device, an electronic storage media (e.g., an integrated circuit (IC), an electronically erasable programmable read-only memory (EEPROM), a flash memory, etc.), a quantum storage device, a cache, and/or any other storage media in which information may be stored for any duration (e.g., for extended time periods, permanently, for brief instances, for temporary buffering, for caching, etc.). As used herein, a computer-readable storage medium expressly excludes any computer-readable media on which signals may be propagated. However, a computer-readable storage medium may include internal signal traces and/or internal signal paths carrying electrical signals thereon.

Any references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of this disclosure, reference has been made to the embodiments illustrated in the drawings, and specific language has been used to describe these embodiments. However, no limitation of the scope of this disclosure is intended by this specific language, and this disclosure should be construed to encompass all embodiments that would normally occur to one of ordinary skill in the art in view of this disclosure.

Disclosed embodiments may be described in terms of functional block components and various processing steps. Such functional blocks may be realized by any number of hardware and/or software components configured to perform the specified functions. For example, the embodiments may employ various integrated circuit components (e.g., memory elements, processing elements, logic elements, look-up tables, and the like) that may carry out a variety of functions under the control of one or more processors or other control devices. Similarly, where the elements of the embodiments are implemented using software programming or software elements, the embodiments may be implemented with any programming or scripting language such as C, C++, Java, assembler, or the like, using any combination of data structures, objects, processes, routines, and other programming elements. Functional aspects may be implemented as instructions executed by one or more processors. Furthermore, the embodiments could employ any number of conventional techniques for electronics configuration, signal processing, control, data processing, and the like. The words “mechanism” and “element” are used broadly and are not limited to mechanical or physical embodiments, but can include software routines in conjunction with processors, etc.

The particular implementations shown and described herein are illustrative examples of the invention and are not intended to otherwise limit the scope of the invention in any way. Furthermore, the connecting lines or connectors shown in the various figures presented are intended to represent exemplary functional relationships and/or physical or logical connections between the various elements. It should be noted that many alternative or additional functional relationships, physical connections or logical connections may be present in a practical device. Moreover, no item or component is essential to the practice of the invention unless the element is specifically described as “essential” or “critical”.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The invention is not limited to the described order of the steps. The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those skilled in this art without departing from the spirit and scope of this disclosure.

What is claimed is:

1. A digital image processing apparatus comprising:
a display unit to display an image;
a tool generation unit to generate an editing tool that applies an image editing effect to a displayed image;
an effect generation unit to generate the image editing effect depending on a movement of the editing tool; and
a contents generation units to generate a moving image including a generation process of the image editing effect and the movement of the editing tool.

2. The digital image processing apparatus of claim 1, wherein the displayed image and the moving image are stored in a single file.

3. The digital image processing apparatus of claim 2, wherein the contents generation unit is to record information relating the displayed image with the moving image in an exchangeable image file format (EXIF) area of the single file.

4. The digital image processing apparatus of claim 1, wherein the displayed image and the moving image are stored in separate files.

5. The digital image processing apparatus of claim 1, wherein the image is a quick view image that is temporarily displayed on the display unit after still image capture.

6. The digital image processing apparatus of claim 5, wherein the editing tool is displayed on the display unit during the performance of an image signal processing due to the still image capture.

7. The digital image processing apparatus of claim 1, wherein the image is an image reproduced from a stored image.

8. The digital image processing apparatus of claim 1, further comprising a manipulation unit to move the editing tool.

9. The digital image processing apparatus of claim 8, wherein the manipulation unit comprises a touch panel.

10. The digital image processing apparatus of claim 8, wherein the manipulation unit comprises input keys.

11. The digital image processing apparatus of claim 1, wherein the editing tool comprises at least one of a watercolor painting brush, an oil painting brush, or a pencil.

12. The digital image processing apparatus of claim 11, wherein the tool generation unit is to generate usable editing tools according to a manipulation signal of a user and then displays the usable editing tools.

13. The digital image processing apparatus of claim 12, wherein the tool generation unit is to display an editing tool selected from among the displayed usable editing tools, and the effect generation unit is to generate an intrinsic image editing effect of the selected editing tool.

14. A method of controlling a digital image processing apparatus, the method comprising:
displaying an image;
displaying an editing tool to generate an image editing effect;
displaying the image editing effect depending on a movement of the editing tool; and
generating a moving image including a generation process of the image editing effect and the movement of the editing tool.

15. The method of claim 14, wherein the displaying of the editing tool comprises:
generating usable editing tools according to a manipulation signal of a user;
displaying the usable editing tools; and
displaying an editing tool selected from among the displayed usable editing tools.

16. The method of claim 15, wherein the displaying of the image editing effect comprises generating an intrinsic image editing effect of the selected editing tool.

17. The method of claim 14, further comprising storing the displayed image and the moving image in separate files.

18. The method of claim 14, further comprising storing the displayed image and the moving image in a single file.

19. The method of claim 14, further comprising capturing a still image,
wherein the displaying of the image comprises displaying a quick view image that is temporarily displayed on a display unit after the capture of the still image.

20. The method of claim 14, further comprising extracting a stored image,
wherein the displaying of the image comprises displaying the extracted image.

21. A digital image processing apparatus comprising:
a storage unit to store a still image and a moving image related to the still image;
a display unit to display the stored still image and moving image; and
a control unit to display the display unit,
wherein the moving image comprises a generation process of an image editing effect generated by a user for the still image and a movement of an editing tool to generate the image editing effect.

22. The digital image processing apparatus of claim 21, wherein the still image or the moving image is selectively reproduced.

23. The digital image processing apparatus of claim 21, wherein, when reproducing the still image, the moving image is first reproduced and the still image is reproduced after the reproduction of the moving image is finished.

24. The digital image processing apparatus of claim 21, wherein the storage unit is to store the still image and the moving image as a single file.

25. The digital image processing apparatus of claim 24, wherein a user interface to execute a reproduction of the moving image is displayed during a reproduction of the still image.

26. The digital image processing apparatus of claim 21, wherein the storage unit is to store the still image and the moving image as separate files.

27. The digital image processing apparatus of claim 21, further comprising a contents generation unit to generate another still image by capturing a frame of the moving image depending on a capture signal when reproducing the moving image.

28. A method of controlling a digital image processing apparatus that stores a still image and a moving image related to the still image, the method comprising:
when reproducing the moving image, reproducing a generation process of an image editing effect generated by a user and a movement of an editing tool to generate the image editing effect.

29. The method of claim 28, wherein the still image or the moving image is selectively reproduced.

30. The method of claim 29, wherein a user interface to execute a reproduction of the moving image is displayed during a reproduction of the still image.

31. The method of claim 28, wherein, when reproducing the still image, the moving image is first reproduced and the still image is reproduced after the reproduction of the moving image is finished.

32. The method of claim 28, wherein, when reproducing the moving image, another still image is generated by capturing a frame of the moving image depending on a capture signal.
